(19) United States
(12) Patent Application Publication
(10) Pub. No.: US 2026/0274343 A1
(43) Pub. Date: Sep. 17, 2026

(54) VEHICLE BODY FRONT STRUCTURE

(71) Applicant: HONDA MOTOR CO., LTD., Tokyo (JP)

(72) Inventors: Yuki SASANUMA, Tokyo (JP); Yui MOMMA, Tokyo (JP); Jusang YOUM, Tokyo (JP)

(21) Appl. No.: 19/456,547

(22) Filed: Jan. 22, 2026

(30) Foreign Application Priority Data
Mar. 13, 2025 (JP) 2025-039907

(51) Int. Cl. B62D 25/08; B60Q 1/04; B60R 11/02; B60R 13/04; G01S 7/02

(52) U.S. Cl. CPC B62D 25/08; B60Q 1/0408; B60R 11/02; B60R 13/04; G01S 7/027

(57) ABSTRACT

A vehicle body front structure includes: a vehicle body frame; a support member attached to the vehicle body frame; a first lamp and a garnish supported by the support member; and a sensor supported by the vehicle body frame and arranged behind the garnish. The first lamp is coupled to the first lamp support, extends forward, and passes above the upper beam. The coupling piece of the garnish enters between the upper surface of the upper beam and the first lamp and is locked by the plurality of locking portions. The upper surface of the upper beam is inclined downward toward a rear, and each of the plurality of locking portions is provided with a first drain hole penetrating in a front-and-rear direction.

### TECHNICAL FIELD

The present invention relates to a vehicle body front structure.

### BACKGROUND ART

In recent years, efforts have been actively made to provide sustainable transportation systems that take into account people in vulnerable situations among traffic participants. To achieve this, research and development of driving assistance technologies for further improving safety and convenience of traffic is being conducted.

Conventionally, a vehicle is provided with a sensor for detecting obstacles around the vehicle to provide driving assistance or autonomous driving. JP7285292B discloses a vehicle body structure including a vehicle body panel, a bumper face covering an outer surface of the vehicle body panel, and a sensor arranged between the vehicle body panel and the bumper face. The sensor transmits and receives radio waves through the bumper face. A lower portion and lateral sides of the sensor are covered by a cover. The cover prevents rainwater, muddy water, dust, and other foreign matters that are splashed up from a road surface and penetrating into the bumper face from adhering to the sensor.

The rainwater and other water may penetrate into an inner surface side of a garnish through a gap between an upper edge of the garnish, such as the bumper face, and an outer surface of the vehicle body panel, and then flow downward along the inner surface of the garnish. When the water adheres to the inner surface of the garnish in front of the sensor, a detection accuracy of the sensor may decrease.

### SUMMARY OF THE INVENTION

In view of the above background, an object of the present invention is to prevent water from adhering to an inner surface of a garnish in front of a sensor in a vehicle body front structure.

To achieve such an object, one aspect of the present invention provides a vehicle body front structure, including: a vehicle body frame; a support member attached to the vehicle body frame; a first lamp and a garnish supported by the support member; and a sensor supported by the vehicle body frame and arranged behind the garnish. An upper edge of the garnish is provided with a coupling piece protruding rearward and extending laterally, the support member includes an upper beam extending laterally, a first lamp support protruding rearward from the upper beam, and a plurality of locking portions provided on an upper surface of the upper beam, the first lamp is coupled to the first lamp support, extends forward, and passes above the upper beam, the coupling piece of the garnish enters between the upper surface of the upper beam and the first lamp and is locked by the plurality of locking portions, the upper surface of the upper beam is inclined downward toward a rear, and each of the plurality of locking portions is provided with a first drain hole penetrating in a front-and-rear direction.

Thus, according to the above aspects, it is possible to prevent water from adhering to the inner surface of the garnish in front of the sensor in the vehicle body front structure.

### BRIEF DESCRIPTION OF THE DRAWING(S)

FIG. 1 is a side view of a left front portion of a vehicle body front structure according to an embodiment of the present invention;

FIG. 2 is a perspective view of a vehicle body frame;

FIG. 3 is a side view of the left front portion of the vehicle body front structure with a garnish omitted;

FIG. 4 is a perspective view of a support member;

FIG. 5 is a cross-sectional view showing a positional relationship between an upper beam and a radar;

FIG. 6 is an enlarged perspective view of a locking portion of the support member;

FIG. 7 is a side view showing the positional relationship between the upper beam and the radar; and

FIG. 8 is a top view showing the positional relationship between the upper beam and the radar.

### DETAILED DESCRIPTION OF THE INVENTION

In the following, a vehicle body front structure according to the present embodiment will be described with reference to the drawings.

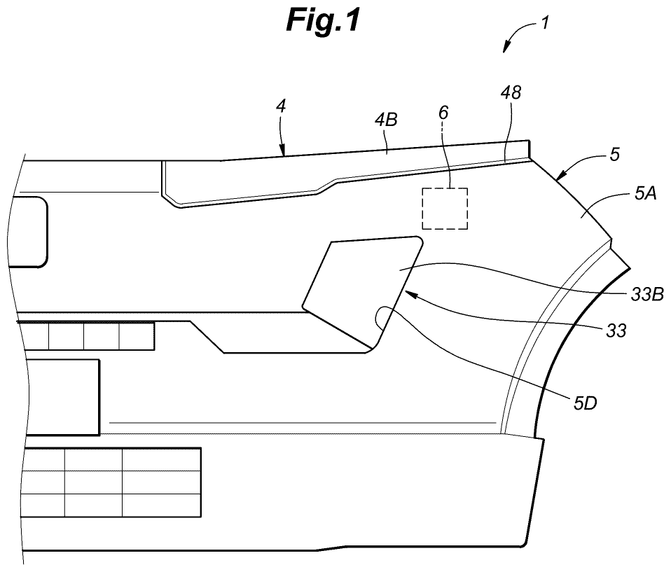

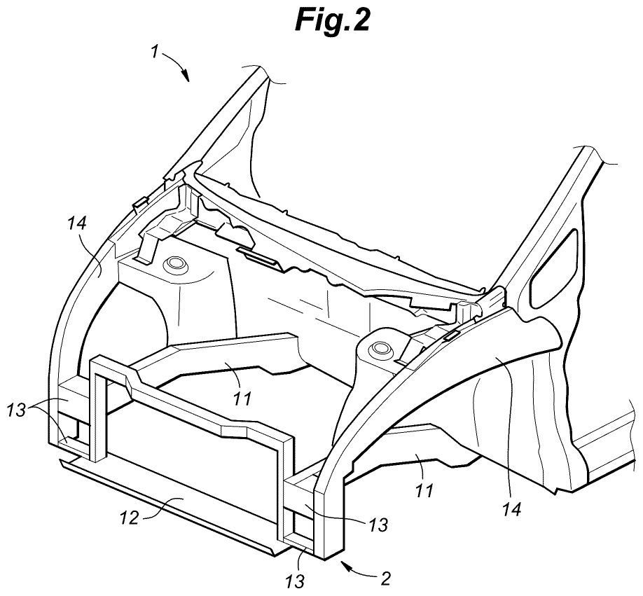

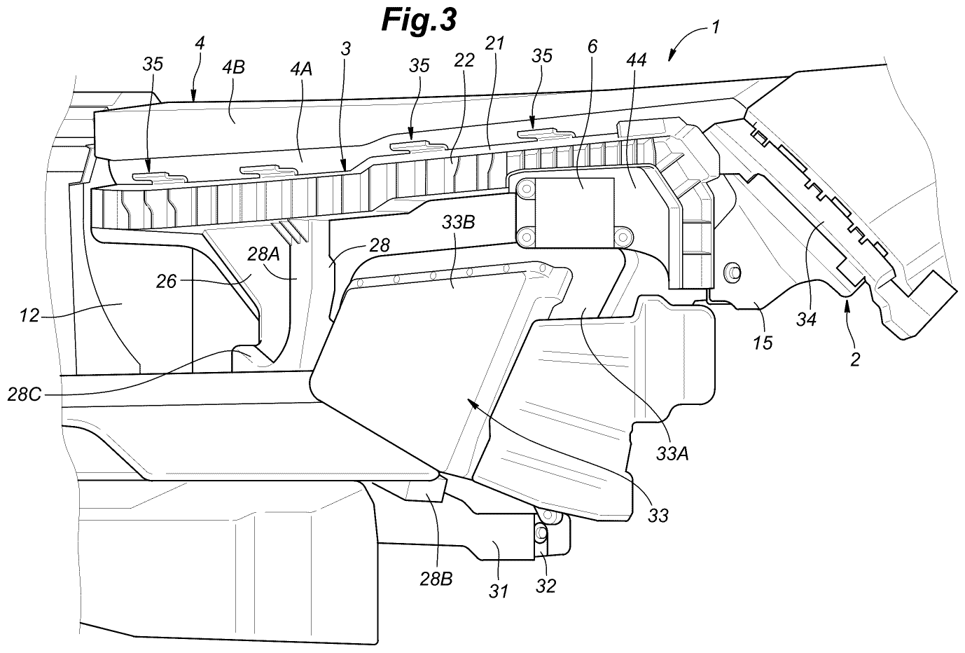

As shown in FIGS. 1 to 3, a vehicle body front structure 1 that constitutes a front portion of a four-wheeled vehicle includes a vehicle body frame 2, a support member 3, a first lamp 4, a garnish 5, and a radar 6 as a sensor. As shown in FIG. 2, the vehicle body frame 2 may include a pair of left and right front side frames 11 extending in a front-and-read direction, a front bulkhead 12 coupled to the front ends of the pair of left and right front side frames 11, and a pair of left and right upper members 14 connected to the front ends of the pair of left and right front side frames 11 and the front bulkhead 12 via a plurality of gussets 13 and extending rearward and upward. As shown in FIG. 3, the vehicle body frame 2 includes a front fender 15 connected to the left and right upper members 14. The front fender 15 is made of a steel plate and constitutes the outer surface of the front side portion of the vehicle.

The support member 3 is attached to the vehicle body frame 2. The first lamp 4 and the garnish 5 are supported by the support member 3. The support member 3 attaches the first lamp 4 and the garnish 5 to the vehicle body frame 2. The support member 3 is provided on each of the left and right portions of the front portion of the vehicle. The support member 3 is preferably made of resin. The resin may be a fiber-reinforced plastic containing glass fibers or carbon fibers. The support member 3 includes an upper beam 21 extending laterally. The outer end of the upper beam 21 in the lateral direction is bent rearward and downward, and extends downward. The upper beam 21 has a substantially rectangular cross section. The upper beam 21 is provided with a plurality of hollowed-out portions 22 that are open toward the front.

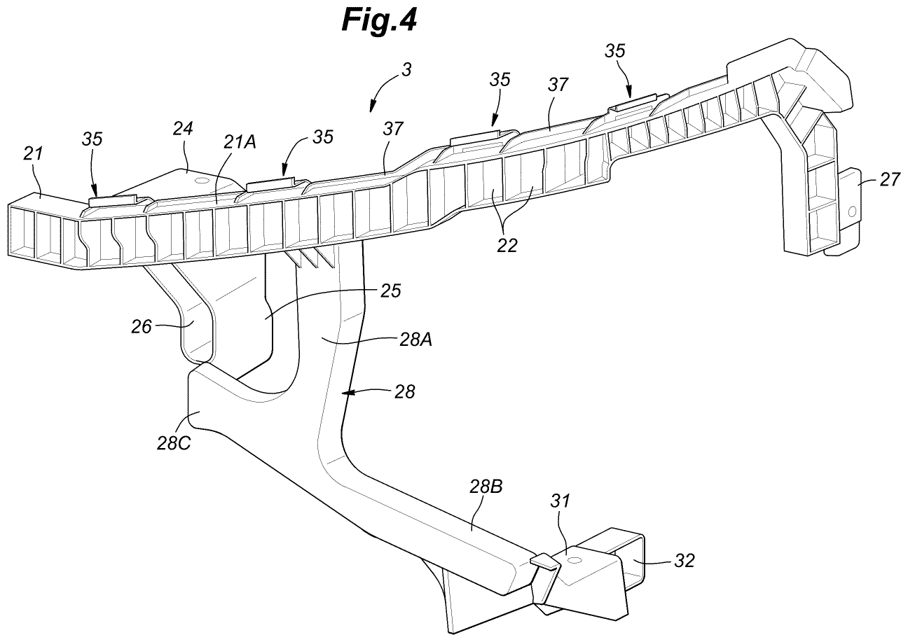

As shown in FIG. 4, the support member 3 includes a first lamp support 24 protruding rearward from the upper beam 21. The first lamp support 24 is formed in a plate shape with the surface thereof facing upward. The support member 3 also includes a first vehicle body coupling portion 25 extending downward from the first lamp support 24. The first vehicle body coupling portion 25 is formed in a plate shape with the surface thereof facing forward, and extends downward from the rear end of the first lamp support 24. The edge portion of the first vehicle body coupling portion 25 is provided with an edge wall 26 that protrudes forward. The edge wall 26 extends along the edge portion of the first vehicle body coupling portion 25. The edge wall 26 may be connected to the side edge of the first lamp support 24. The edge wall 26 increases the rigidity of the first vehicle body coupling portion 25 and the first lamp support 24.

The first vehicle body coupling portion 25 is fastened to the front bulkhead 12 by a fastener, such as a screw. More specifically, the first vehicle body coupling portion 25 may be fastened to the left and right side portions of the front bulkhead 12. A second vehicle body coupling portion 27 is provided at the outer end of the upper beam 21. The second vehicle body coupling portion 27 is fastened to the front end of the corresponding front fender 15 on the left and right sides by a fastener, such as a screw. The upper beam 21 extends from the front bulkhead 12 to the front fender 15.

The support member 3 includes an arm portion 28 extending downward from the upper beam 21. The arm portion 28 is arranged closer to the center of the upper beam 21 than the first lamp support 24, and includes an arm upper portion 28A extending downward from the upper beam 21, and an arm lower portion 28B extending from the lower end of the arm upper portion 28A and inclined downward and laterally outward. A second lamp support 31 protruding rearward is provided at the lower end of the arm lower portion 28B. The second lamp support 31 includes a plate-shaped upper portion that faces upward. The rear end of the second lamp support 31 is provided with a third vehicle body coupling portion 32 that protrudes rearward. The third vehicle body coupling portion 32 includes the plate-shaped side portions facing laterally outward. The third vehicle body coupling portion 32 is fastened to the corresponding upper member 14 on the left and right sides by a fastener, such as a screw.

The arm portion 28 may include an arm extending portion 28C connecting the upper end of the arm lower portion 28B and the first vehicle body coupling portion 25. The arm extending portion 28C extends laterally inward and upward from the upper end of the arm lower portion 28B, and is connected to the first vehicle body coupling portion 25 via the edge wall 26.

The first lamp support 24 supports the first lamp 4. The first lamp 4 constitutes at least one of a headlight and a turn signal indicator. In the present embodiment, the first lamp 4 constitutes the turn signal indicator. As shown in FIG. 3, the first lamp 4 includes a first lamp housing 4A having the opening at the front end, and a light-transmitting first lamp cover 4B that closes the opening of the first lamp housing 4A. The first lamp housing 4A is provided therein with the light source and a lens unit that guides the light generated by the light source toward the first lamp cover 4B. The light generated by the light source is guided forward by the lens unit, passes through the first lamp cover 4B, and is emitted toward the front of the vehicle.

The first lamp housing 4A extends laterally. The lower portion of the first lamp housing 4A is supported from below by the first lamp support 24 and is fastened to the first lamp support 24 by the fastener, such as a screw.

The first lamp cover 4B is provided at the front end of the first lamp housing 4A and extends laterally. The first lamp cover 4B protrudes forward relative to the front end of the first lamp housing 4A. That is, the first lamp 4 passes above the upper beam 21 and extends forward. The front end of the first lamp cover 4B protrudes above the upper beam 21. A gap is formed between the lower end of the first lamp cover 4B and an upper surface 21A of the upper beam 21.

The second lamp support 31 supports a second lamp 33. The second lamp 33 constitutes at least one of the headlight and the turn signal indicator. In the present embodiment, the second lamp 33 constitutes the headlight. Similar to the first lamp 4, the second lamp 33 includes a second lamp housing 33A, a second lamp cover 33B, a light source, and a lens unit. The lower portion of the second lamp housing 33A is supported from below by the second lamp support 31 and is fastened to the second lamp support 31 by the fastener, such as a screw.

The second lamp cover 33B is provided at the front end of the second lamp housing 33A. The second lamp cover 33B protrudes forward relative to the front end of the second lamp housing 33A. The front end of the second lamp cover 33B protrudes above the arm lower portion 28B. A gap is formed between the lower end of the second lamp cover 33B and the upper surface of the arm lower portion 28B.

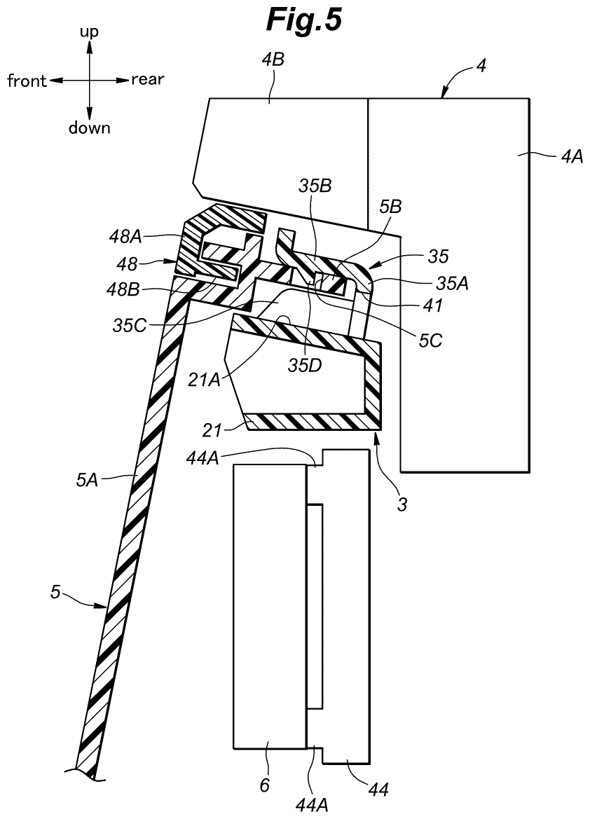

The garnish 5 is also referred to as a bumper face. As shown in FIG. 5, the garnish 5 includes a side plate portion 5A that forms the outer surface of the vehicle body, and a coupling piece 5B that protrudes rearward from the upper edge of the side plate portion 5A and extends laterally. The side plate portion 5A hides the vehicle body frame 2 and the support member 3. The garnish 5 is preferably made of a resin material that transmits radio waves. As shown in FIG. 1, the side plate portion 5A includes an opening 5D for exposing the second lamp 33 to the outside. The garnish 5 is supported by the support member 3 at the coupling piece 5B. The coupling piece 5B is also supported by a retainer 34 provided on the front fender 15.

As shown in FIG. 5, the coupling piece 5B is formed in a plate shape that generally faces in the up-and-down direction. A plurality of locking holes 5C is formed in the coupling piece 5B. The plurality of locking holes 5C is arranged at intervals from each other in the lateral direction.

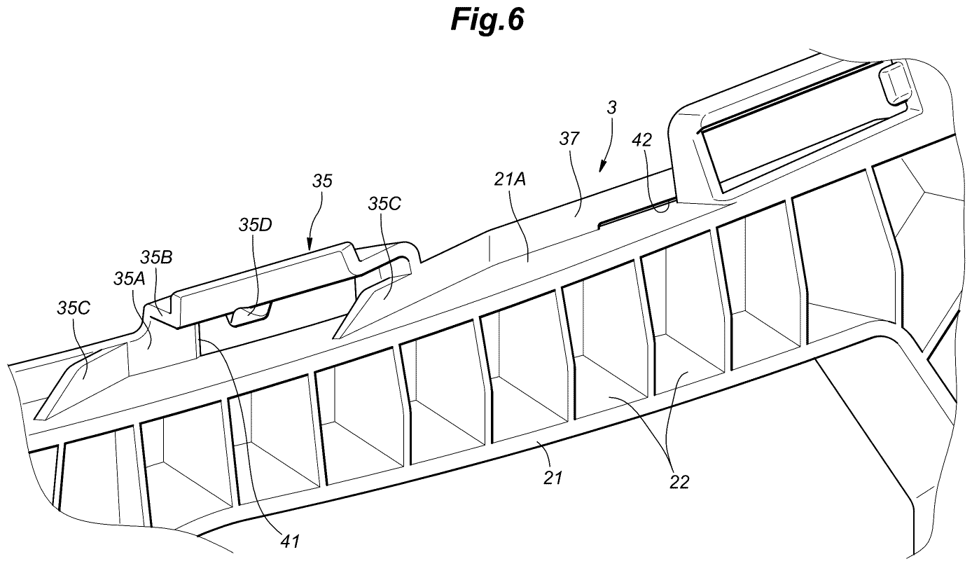

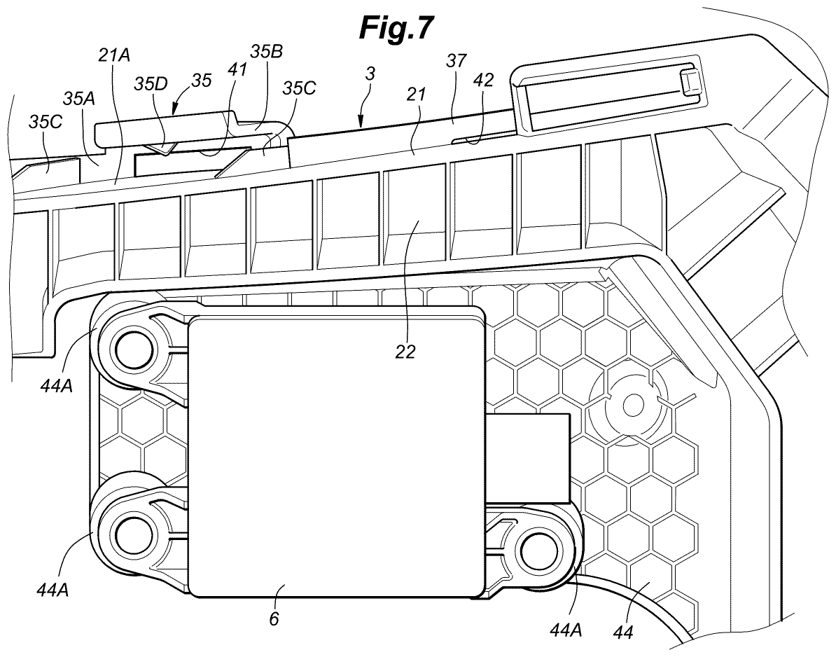

The upper surface 21A of the upper beam 21 is inclined downward toward the rear. As shown in FIGS. 5, 6, and 7, the upper surface 21A of the upper beam 21 is provided with a plurality of locking portions 35. The locking portions 35 are spaced apart from each other in the lateral direction. Each locking portion 35 includes an upright wall 35A extending upward from the rear end of the upper surface 21A of the upper beam 21, a transverse wall 35B extending forward from the upper end of the upright wall 35A, and a pair of guide walls 35C extending forward from the lower portions of the left and right side edges of the upright wall 35A and coupled to the upper surface 21A of the upper beam 21. The upright wall 35A is formed in a plate shape with the surface thereof facing forward and rearward. The transverse wall 35B is formed in the shape of a plate with the surface thereof facing upward and downward. Each guide wall 35C decreases in height toward the front. The front end of each guide wall 35C is arranged so as to be offset rearward relative to the front end of the upper beam 21.

The coupling piece 5B of the garnish 5 enters between the upper surface 21A of the upper beam 21 and the first lamp 4 and is locked to the plurality of locking portions 35. The coupling piece 5B of the garnish 5 is inserted into the space between the transverse wall 35B and a pair of guide walls 35C in each locking portion 35. Each guide wall 35C guides the coupling piece 5B toward the transverse wall 35B. The lower surface of each transverse wall 35B is provided with a claw 35D that protrudes downward. Each claw 35D locks the corresponding locking hole 5C of the coupling piece 5B. This allows the garnish 5 to be supported by the support member 3.

The upper surface 21A of the upper beam 21 is provided with a reinforcement wall 37 that protrudes upward and extends laterally. The reinforcement wall 37 is connected to the plurality of locking portions 35. More specifically, the reinforcement wall 37 is connected to the upright wall 35A of the adjacent locking portion 35. The reinforcement wall 37 extends along the rear edge of the upper surface 21A of the upper beam 21.

Each of the plurality of locking portions 35 is provided with a first drain hole 41 penetrating in the front-and-rear direction. Each first drain hole 41 is formed in the upright wall 35A of each locking portion 35. The reinforcement wall 37 is provided with a plurality of second drain holes 42 penetrating in the front-and-rear direction.

The radar 6 may be, for example, a millimeter wave radar. The radar 6 may be formed, for example, in a flat rectangular parallelepiped shape. As shown in FIG. 3, the radar 6 is supported by the vehicle body frame 2. A sensor bracket 44 is coupled to the front end of the front fender 15, and the radar 6 is coupled to the sensor bracket 44. The sensor bracket 44 is formed in a plate shape. The sensor bracket 44 extends forward from the front end of the front fender 15. The main surface of the sensor bracket 44 preferably faces forward, or forward and laterally outward. The sensor bracket 44 may be made of a resin material or a metal plate. The radar 6 may be fastened to the front surface of the sensor bracket 44 by a fastener, such as a screw. The surface of the sensor bracket 44 may be provided with reinforcing ribs to increase rigidity. The reinforcing ribs may have, for example, a honeycomb structure.

As shown in FIG. 5, the front surface of the sensor bracket 44 includes a plurality of bosses 44A protruding forward. The radar 6 is fastened to the distal ends of the plurality of bosses 44A. This creates a gap between the front surface of the sensor bracket 44 and the radar 6.

The radar 6 is arranged behind the garnish 5. A gap is formed between the radar 6 and the inner surface of the garnish 5. The radar 6 transmits radio waves to the outboard side, that is, toward the garnish 5. In the present embodiment, the radar 6 transmits radio waves forward and laterally outward from the corners of the front portion of the vehicle.

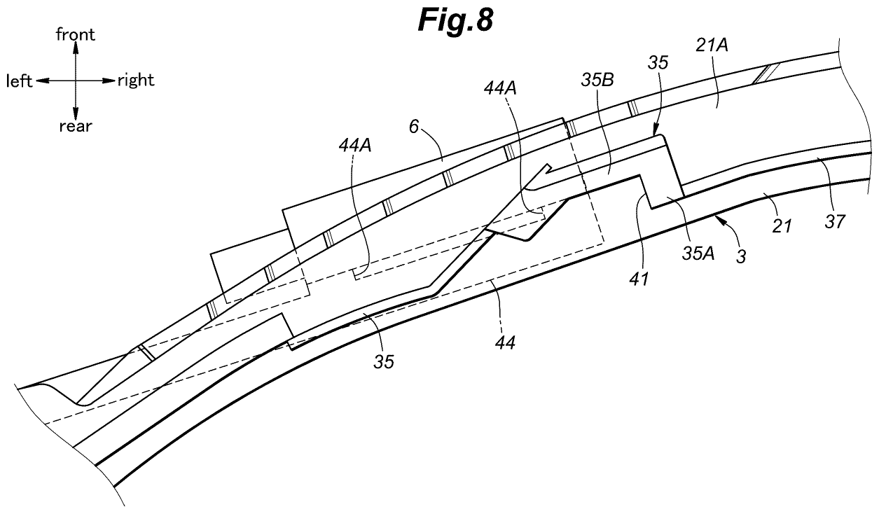

As shown in FIGS. 1 and 3, the radar 6 is arranged below the upper beam 21. The radar 6 is arranged above the second lamp 33. As shown in FIGS. 5 and 8, the rear end of the radar 6 is arranged forward of the rear end of the upper beam 21. The rear end of the sensor bracket 44 may be arranged forward of the rear end of the upper beam 21.

As shown in FIGS. 1 and 5, a sealing member 48 is provided to fill the gap between the upper edge of the garnish 5 and the lower edge of the first lamp cover 4B of the first lamp 4. The sealing member 48 extends laterally along the gap between the upper edge of the garnish 5 and the lower edge of the first lamp cover 4B of the first lamp 4. The sealing member 48 includes an outer wall 48A with a main surface thereof facing in the front-and-rear direction, and a plurality of locking claws 48B extending rearward from the inner surface of the outer wall 48A. Each locking claw 48B may be hooked onto the coupling piece 5B of the garnish 5.

The functions and effects of the vehicle body front structure 1 described above will now be described. The sealing member 48 fills the gap between the lower edge of the first lamp cover 4B of the first lamp 4 and the upper edge of the garnish 5, and prevents the penetration of water, such as rainwater. However, water may penetrate the gap between the lower edge of the first lamp cover 4B and the sealing member 48 or the gap between the upper edge of the garnish 5 and the sealing member 48. In this case, the water flows along the upper surface of the coupling piece 5B of the garnish 5 and flows from the rear edge of the coupling piece 5B or a plurality of locking holes 5C to the upper surface 21A of the upper beam 21. Since the upper surface 21A of the upper beam 21 is inclined downward toward the rear, the water flows rearward on the upper surface 21A of the upper beam 21. Further, on the upper surface 21A of the upper beam 21, since the first drain hole 41 is provided in each of the locking portions 35, and the second drain holes 42 are provided in the reinforcement wall 37, the water is prevented from accumulating in the locking portions 35 and the reinforcement wall 37. This prevents the water from dropping from the front side of the upper beam 21 and prevents the water from flowing along the inner surface of the side plate portion 5A of the garnish 5. Further, the water is prevented from adhering to the front surface of the radar 6.

Since the rear end of the radar 6 is arranged forward of the rear end of the upper beam 21, the water dropping from the rear end of the upper beam 21 is less likely to adhere to the radar 6. Further, since a gap is formed between the radar 6 and the front surface of the sensor bracket 44, even if the water adheres to the sensor bracket 44, the water is less likely to flow from the sensor bracket 44 to the radar 6.

The embodiment is not limited to the above configuration and can be widely modified and implemented. For example, the sensor may be another obstacle detection sensor, such as a light detection and ranging (LiDAR) or a camera, instead of the radar 6. When the sensor is a LiDAR or a camera, the garnish 5 may be made of a material that transmits the light emitted by the LiDAR.

The sensor bracket 44 may be coupled to the support member 3 instead of the vehicle body frame 2. The sensor bracket 44 may also be formed as a portion of the support member 3. For example, the sensor bracket 44 may extend downward from the lower surface of the upper beam 21. The upper surface of the sensor bracket 44 is preferably inclined downward toward the rear. Accordingly, water dropping onto the upper surface of the sensor bracket 44 flows in a rearward direction away from the radar 6.

The cover may be provided around the radar 6. The cover preferably includes at least the overhang portion arranged above the radar 6. The cover may be formed in a tubular shape extending in a front-and-rear direction. The rear end of the cover may be coupled to the sensor bracket 44. The radar 6 is preferably arranged inside the cover. The vertical and lateral dimensions of the cover may increase toward the front. The overhang portion of the cover may be arranged between the upper end of the radar 6 and the lower surface of the upper beam 21. The front end of the overhang portion of the cover may be arranged forward of the front end of the radar 6. The overhang portion can prevent water dropping from the upper beam 21 from adhering to the radar 6.

The reinforcement wall 37 of the upper beam 21 may be omitted. Further, the arm portion 28 of the support member 3 may be omitted.

The above embodiment may also be described as follows:

One embodiment provides a vehicle body front structure 1, including: a vehicle body frame 2; a support member 3 attached to the vehicle body frame 2; a first lamp 4 and a garnish 5 supported by the support member 3; and a sensor (radar 6) supported by the vehicle body frame 2 and arranged behind the garnish 5. An upper edge of the garnish 5 is provided with a coupling piece 5B protruding rearward and extending laterally, the support member 3 includes an upper beam 21 extending laterally, a first lamp support 24 protruding rearward from the upper beam 21, and a plurality of locking portions 35 provided on an upper surface 21A of the upper beam 21, the first lamp 4 is coupled to the first lamp support 24, extends forward, and passes above the upper beam 21, the coupling piece 5B of the garnish 5 enters between the upper surface 21A of the upper beam 21 and the first lamp 4 and is locked by the plurality of locking portions 35, the upper surface 21A of the upper beam 21 is inclined downward toward a rear, and each of the plurality of locking portions 35 is provided with a first drain hole 41 penetrating in a front-and-rear direction.

According to this aspect, water that penetrates the gap between the upper edge of the garnish 5 and the first lamp 4 and flows to the upper beam 21 is discharged from the rear end of the upper beam 21. Further, in each of the locking portions 35, water is discharged rearward through the first drain hole 41, so that water does not accumulate in the locking portions 35. Accordingly, the water is prevented from flowing forward from the front end of the upper beam 21, and the water is prevented from adhering to the inner surface of the garnish 5. Accordingly, it is possible to prevent water from adhering to the inner surface of the garnish 5 in front of the sensor (the radar 6) in the vehicle body structure.

In the above embodiment, preferably, the upper surface 21A of the upper beam 21 is provided with a reinforcement wall 37 protruding upward and extending laterally, the reinforcement wall 37 is connected to the plurality of locking portions 35, and the reinforcement wall 37 is provided with a plurality of second drain holes 42 penetrating in the front-and-rear direction.

According to this aspect, in the reinforcement wall 37, water is discharged rearward through the second drain holes 42, so that the water does not accumulate in the reinforcement wall 37. Accordingly, the water is prevented from flowing forward from the front end of the upper beam 21, and the water is prevented from adhering to the inner surface of the garnish 5.

In the above embodiment, preferably, the sensor (radar 6) is arranged below the upper beam 21, and a rear end of the sensor (radar 6) is arranged forward of a rear end of the upper beam 21.

According to this aspect, water flowing downward from the rear end of the upper beam 21 is less likely to adhere to the sensor (the radar 6).

In the above embodiment, preferably, the support member 3 includes an arm portion 28 extending downward from the upper beam 21, a second lamp support 31 that supports a second lamp 33 is provided on a lower portion of the arm portion 28, and the sensor (radar 6) is arranged above the second lamp 33.

According to this aspect, the space between the first lamp 4 and the second lamp 33 can be used to arrange the sensor (the radar 6).

In the above embodiment, preferably, the sensor (radar 6) is supported by a front portion of a sensor bracket 44 provided on the vehicle body frame 2.

According to this aspect, since the sensor bracket 44 is provided on the vehicle body frame 2, which has higher rigidity than the support member 3, the position of the sensor (the radar 6) is stabilized.

In the above embodiment, preferably, the sensor bracket 44 includes a plurality of bosses 44A protruding forward, and the sensor (radar 6) is coupled to the plurality of bosses 44A.

According to this aspect, water adhering to the sensor bracket 44 is less likely to flow to the radar 6.

In the above embodiment, preferably, the sensor is a radar 6.

1. A vehicle body front structure, comprising:
a vehicle body frame;
a support member attached to the vehicle body frame;
a first lamp and a garnish supported by the support member; and
a sensor supported by the vehicle body frame and arranged behind the garnish, wherein
an upper edge of the garnish is provided with a coupling piece protruding rearward and extending laterally,
the support member includes an upper beam extending laterally, a first lamp support protruding rearward from the upper beam, and a plurality of locking portions provided on an upper surface of the upper beam,
the first lamp is coupled to the first lamp support, extends forward, and passes above the upper beam,
the coupling piece of the garnish enters between the upper surface of the upper beam and the first lamp and is locked by the plurality of locking portions,
the upper surface of the upper beam is inclined downward toward a rear, and
each of the plurality of locking portions is provided with a first drain hole penetrating in a front-and-rear direction.

2. The vehicle body front structure according to claim 1, wherein the upper surface of the upper beam is provided with a reinforcement wall protruding upward and extending laterally,
the reinforcement wall is connected to the plurality of locking portions, and
the reinforcement wall is provided with a plurality of second drain holes penetrating in the front-and-rear direction.

3. The vehicle body front structure according to claim 2, wherein the sensor is arranged below the upper beam, and
a rear end of the sensor is arranged forward of a rear end of the upper beam.

4. The vehicle body front structure according to claim 3, wherein the support member includes an arm portion extending downward from the upper beam,
a second lamp support that supports a second lamp is provided on a lower portion of the arm portion, and
the sensor is arranged above the second lamp.

5. The vehicle body front structure according to claim 3, wherein the sensor is supported by a front portion of a sensor bracket provided on the vehicle body frame.

6. The vehicle body front structure according to claim 5, wherein the sensor bracket includes a plurality of bosses protruding forward, and
the sensor is coupled to the plurality of bosses.

7. The vehicle body front structure according to claim 1, wherein the sensor is a radar.
